(19) United States
(12) Patent Application Publication
(10) Pub. No.: US 2023/0377010 A1
(43) Pub. Date: Nov. 23, 2023

(54) INFORMATION PROCESSING APPARATUS, INFORMATION PROCESSING METHOD, AND PROGRAM

(71) Applicant: NEC Corporation, Tokyo (JP)

(72) Inventor: Tomoshige FUNASAKI, Tokyo (JP)

(73) Assignee: NEC Corporation, Tokyo (JP)

(21) Appl. No.: 18/196,801

(22) Filed: May 12, 2023

(30) Foreign Application Priority Data
May 19, 2022 (JP) 2022-082502

(51) Int. Cl. G06Q 30/0601; G06Q 20/40

(52) U.S. Cl. CPC G06Q 30/0603; G06Q 20/401

(57) ABSTRACT

In order to enable an intersystem linkage for each combination between an EC website and a store or the like that is a receiving facility, an information processing apparatus includes: a storage unit (11) that stores consent information in a case where the consent information has been acquired, the consent information indicating consent of a user regarding linkage between a first server (EC website) and a second server (store); an acquisition unit (12) that acquires, from one of the first server and the second server, linkage target information that is to be subjected to information linkage; and a provision unit (13) that carries out, in a case where the consent information is stored in the storage unit (11), a provision process for providing the linkage target information to the other of the first server and the second server.

This Nonprovisional application claims priority under 35 U.S.C. § 119 on Patent Application No. 2022-082502 filed in Japan on May 19, 2022, the entire contents of which are hereby incorporated by reference.

### TECHNICAL FIELD

The present invention relates to an information processing apparatus, an information processing method, and a program.

### BACKGROUND ART

Mainly major electronic commerce (EC) websites conventionally support, through cooperation with, for example, convenience stores and delivery locker companies (home-delivery companies), receipt of products at various receiving facilities. Examples of a technique related to the above include the following invention disclosed in Patent Literature 1.

An ID linkage system disclosed in Patent Literature 1 includes an ID registration means that registers, in association with a third ID which is associated with a first user by the ID linkage system, (i) a first ID which is associated with the first user by a first service system and (ii) a second ID which is associated with the first user by a second service system.

### CITATION LIST

### Patent Literature

### [Patent Literature 1]

Japanese Patent Application Publication Tokukai No. 2021-144385

### SUMMARY OF INVENTION

### Technical Problem

As described above, EC websites support, through cooperation with, for example, convenience stores and delivery locker companies, receipt of products at various receiving facilities. However, a place at which a user can receive a product is limited.

Patent Literature 1 discloses registering, in association with the third ID which is associated with the first user by the ID linkage system, (i) the first ID which is associated with the first user by the first service system and (ii) the second ID which is associated with the first user by the second service system. In order to enable a user to receive a product at a receiving facility, intersystem linkage is necessary for each combination between an EC website and a store or the like that is a receiving facility. However, linkage that is unintended by the user may be carried out in Patent Literature 1.

An example aspect of the present invention has been made in view of the above problems, and an example object thereof is to provide a technique that enables intersystem linkage for each combination between an EC website and a store or the like that is a receiving facility.

### Solution to Problem

An information processing apparatus in accordance with an example aspect of the present invention includes at least one processor, the at least one processor carrying out: a storage process for storing consent information in a storage unit in a case where the consent information has been acquired, the consent information indicating consent of a user regarding linkage between a first server and a second server; and an acquisition process for acquiring, from one of the first server and the second server, linkage target information that is to be subjected to information linkage, the at least one processor carrying out, in a case where the consent information is stored in the storage unit, a provision process for providing the linkage target information to the other of the first server and the second server, and not carrying out, in a case where the consent information is not stored in the storage unit, the provision process for providing the linkage target information to the other of the first server and the second server.

An information processing apparatus in accordance with an example aspect of the present invention includes at least one processor, the at least one processor carrying out: an acquisition process for acquiring, from a user, an instruction to purchase a product; a transmission process for transmitting a request to a linkage server that links the information processing apparatus with another server; an acquisition process for acquiring, from the linkage server, at least one receivable place at which the product is receivable and which is associated with second authentication information that is associated with first authentication information used in the information processing apparatus to authenticate the user; and a presentation process for presenting, to the user, presentation information including the at least one receivable place.

An information processing method in accordance with an example aspect of the present invention includes: storing consent information in a storage unit in a case where the consent information has been acquired, the consent information indicating consent of a user regarding linkage between a first server and a second server; and acquiring, from one of the first server and the second server, linkage target information that is to be subjected to information linkage, wherein a provision process for providing the linkage target information to the other of the first server and the second server is carried out in a case where the consent information is stored in the storage unit, and the provision process for providing the linkage target information to the other of the first server and the second server is not carried out in a case where the consent information is not stored in the storage unit.

An information processing method in accordance with an example aspect of the present invention includes: acquiring, from a user, an instruction to purchase a product; transmitting a request to a linkage server that links an information processing apparatus with another server; acquiring, from the linkage server, at least one receivable place at which the product is receivable and which is associated with second authentication information that is associated with first authentication information used in the information processing apparatus to authenticate the user; and presenting, to the user, presentation information including the at least one receivable place.

A program stored in a non-transitory storage medium in accordance with an example aspect of the present invention causes a computer to carry out: a storage process for storing consent information in a storage unit in a case where the consent information has been acquired, the consent information indicating consent of a user regarding linkage between a first server and a second server; and an acquisition process for acquiring, from one of the first server and the second server, linkage target information that is to be subjected to information linkage, the computer carrying out, in a case where the consent information is stored in the storage unit, a provision process for providing the linkage target information to the other of the first server and the second server, and not carrying out, in a case where the consent information is not stored in the storage unit, the provision process for providing the linkage target information to the other of the first server and the second server.

A program stored in a non-transitory storage medium in accordance with an example aspect of the present invention causes a computer to carry out: an acquisition process for acquiring, from a user, an instruction to purchase a product; a transmission process for transmitting a request to a linkage server that links an information processing apparatus with another server; an acquisition process for acquiring, from the linkage server, at least one receivable place at which the product is receivable and which is associated with second authentication information that is associated with first authentication information used in the information processing apparatus to authenticate the user; and a presentation process for presenting, to the user, presentation information including the at least one receivable place.

### Advantageous Effects of Invention

An example aspect of the present invention makes it possible to enable intersystem linkage for each combination between an EC website and a store or the like that is a receiving facility.

### BRIEF DESCRIPTION OF DRAWINGS

FIG. 1 is a block diagram illustrating an example configuration of a first information processing apparatus in accordance with a first example embodiment of the present invention.

FIG. 2 is a flowchart showing a flow of an information processing method carried out by the first information processing apparatus in accordance with the first example embodiment of the present invention.

FIG. 3 is a block diagram illustrating an example configuration of a second information processing apparatus in accordance with the first example embodiment of the present invention.

FIG. 4 is a flowchart showing a flow of an information processing method carried out by the second information processing apparatus in accordance with the first example embodiment of the present invention.

FIG. 5 is a diagram illustrating an example of an ID linkage system in accordance with a second example embodiment of the present invention.

FIG. 6 is a view for describing an ID linkage service.

FIG. 7 is a view illustrating an example of a data structure stored in a storage unit of the first information processing apparatus.

FIG. 8 is a sequence diagram (part 1) showing a flow of an information processing method carried out by the ID linkage system in accordance with the second example embodiment of the present invention.

FIG. 9 is a sequence diagram (part 2) showing the flow of the information processing method carried out by the ID linkage system in accordance with the second example embodiment of the present invention.

FIG. 10 is a view illustrating an example of a receiving facility displayed in a terminal apparatus of a user.

FIG. 11 is a view illustrating an example of a receiving facility displayed on a map.

FIG. 12 is a block diagram illustrating a configuration of a computer functioning as the information processing apparatus in accordance with each of the example embodiments.

### EXAMPLE EMBODIMENTS

### Background of Invention

In the current buy online pickup in shop (BOPIS), mainly major EC websites support, through cooperation with, for example, convenience stores and delivery lockers (home-delivery companies), receipt of products at various receiving facilities. However, a place at which a user can receive a product is limited.

Furthermore, system linkage for each EC website is necessary for a receiving facility so that a product on an EC website can be received at a store or the like. Investment in such system linkage results in a heavy load on the receiving facility. Furthermore, at a store, a user who receives a product at the store is expected to make an unplanned purchase. However, information pertaining to the user who comes to the store to receive the product is not linked with the receiving facility. This prevents personalized sales promotion measures from being carried out.

The present invention links, in BOPIS that allows a product on an EC website to be received at a store, a user ID between the EC website on which the product is sold and a store at which the product is received. Such ID linkage and agreement/consent of a user allow distribution of purchase data of the user between the EC website and the store. This enables user data utilization (sales promotion measures) that cannot be achieved by conventional BOPIS.

### First Example Embodiment

<First Information Processing Apparatus 1 in Accordance with First Example Embodiment>

A first example embodiment of the present invention will be described in detail with reference to the drawings. The first example embodiment is an embodiment serving as a basis for example embodiments described later. Note that in this overview, reference numerals in the drawings are assigned, for convenience, to respective elements as an example for easier understanding, and are not intended to limit the present invention to aspects illustrated in the drawings. Furthermore, a direction in which connecting lines between blocks in, for example, the drawings to be referred to in the following description extend includes both a single direction and two directions. A unidirectional arrow schematically illustrates a flow of a main signal (data) and is not intended to exclude bidirectionality. Moreover, a point of connection between an input and an output of each of the blocks in the drawings may be configured to be provided with a port or an interface. However, such a configuration is not illustrated.

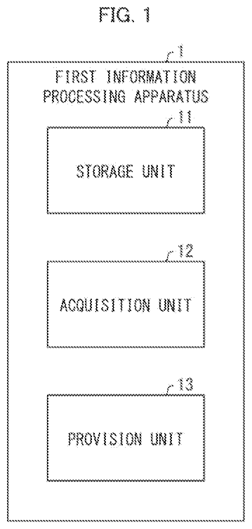

FIG. 1 is a block diagram illustrating an example configuration of a first information processing apparatus 1 in accordance with the first example embodiment of the present invention. The first information processing apparatus 1 in accordance with the first example embodiment includes a storage unit 11, an acquisition unit 12, and a provision unit 13 (see FIG. 1).

The storage unit 11 is configured to achieve a storage means in the first example embodiment. The acquisition unit 12 is configured to achieve an acquisition means in the first example embodiment. The provision unit 13 is configured to achieve a provision means in the first example embodiment.

The storage unit 11 stores consent information in a case where consent information is acquired, the consent information indicating consent of a user regarding linkage between a first server and a second server. The first server is a server that is provided on an EC website or a store website. The second server is a server different from the first server, and is provided on the store website in a case where the first server is provided on the EC website. The second server is provided on the EC website in a case where the first server is provided on the store website.

The EC website is a concept including a website of, for example, a retail store at which a product is sold. The EC website includes websites of, for example, a supermarket and a drugstore. The store website is a concept including a website of a facility at which a product can be received. The store website includes websites of, for example, a convenience store, a delivery locker, a hospital, a supermarket, and a drugstore. A website of a facility at which a product can be sold and at which a product can be received, such as a supermarket or a drugstore can be the EC website or can be the store website.

The consent information is information indicating that the user has agreed to linkage between personal data (PD) information pertaining to the user and managed by the first server and PD information pertaining to the user and managed by the second server. For example, in a case where the first server is provided on the EC website and the second server is provided on the store website, the consent information indicates that the user has agreed to linkage between the PD information pertaining to the user and managed by the EC website and the PD information pertaining to the user and managed by the store website.

Note that a user ID in the first server and a user ID in the second server may be linked so as to achieve linkage between PD pertaining to the user and managed by the first server and PD pertaining to the user and managed by the second server. Linkage between the user ID in the first server and the user ID in the second server is hereinafter referred to as user ID linkage.

The storage unit 11 is constituted by, for example, a nonvolatile memory such as a flash memory, or a hard disk, and stores and holds the consent information that is acquired from a user.

The acquisition unit 12 acquires, from one of the first server and the second server, linkage target information that is to be subjected to information linkage. The linkage target information that is to be subjected to information linkage includes purchase information and delivery destination specifying information.

The purchase information is information pertaining to a product that the user has purchased on the EC website. The purchase information includes, for example, a purchased product, a quantity, a unit price, purchase date and time, and a payment method. The delivery destination specifying information is information pertaining to a store at which the user is to receive a product. The delivery destination includes, for example, information such as a store name, a store address, receipt date and time, a payment method, sex of the user, and a user age bracket.

In a case where the consent information is stored in the storage unit 11, the provision unit 13 carries out a provision process for providing the linkage target information to the other of the first server and the second server. In a case where the consent information is not stored in the storage unit 11, the provision unit 13 does not carry out the provision process for providing the linkage target information to the other of the first server and the second server.

In a case where there is a request, from the user or, for example, a business operator serving as a provider of the user ID, to use the user ID to provide the linkage target information, the provision unit 13 refers to the storage unit 11 and determines whether the consent information that corresponds to the user ID linkage is stored. Note here that the business operator serving as the provider of the user ID is a business operator that operates the EC website, such as a supermarket or a drugstore, a business operator that operates the store website, such as a convenience store, or a business operator such as a delivery locker or a hospital.

In a case where the consent information that corresponds to the user ID linkage is stored in the storage unit 11, the provision unit 13 carries out the provision process for providing the linkage target information to the other (the server different from the server that has been requested to provide the linkage target information and that corresponds to the user ID linkage) of the first server and the second server.

In contrast, in a case where the consent information that corresponds to the user ID linkage is not stored in the storage unit 11, the provision unit 13 does not carry out the provision process for providing the linkage target information to the other (the server different from the server that has been requested to provide the linkage target information and that corresponds to the user ID linkage) of the first server and the second server.

The first information processing apparatus 1 may include a determination unit that, in a case where the consent information is stored in the storage unit 11, carries out a process for determining, in accordance with the consent information, whether it is proper to provide the linkage target information to the other of the first server and the second server.

<Effect of First Information Processing Apparatus 1>

As described above, according to the first information processing apparatus 1 in accordance with the first example embodiment, in a case where the consent information that corresponds to the user ID linkage is stored in the storage unit 11, the provision unit 13 carries out the provision process for providing the linkage target information to the other of the first server and the second server. This makes it possible to enable intersystem linkage for each combination between an EC website and a store or the like that is a receiving facility.

<Flow of Information Processing Method Carried Out by First Information Processing Apparatus 1>

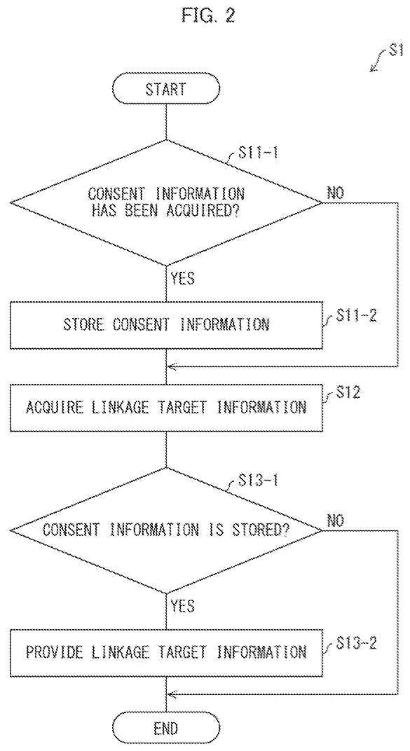

The following description discusses, with reference to FIG. 2, a flow of an information processing method carried out by the first information processing apparatus 1 configured as described above. FIG. 2 is a flowchart showing the flow of the information processing method. As illustrated in FIG. 2, an information processing method S1 includes steps S11-1 to S13-2.

First, the acquisition unit 12 determines whether the consent information indicating consent of the user regarding linkage between the first server and the second server has been acquired (S11-1). In a case where the acquisition unit 12 does not acquire the consent information (No in S11-1), the process proceeds to the step S12. In a case where the acquisition unit 12 acquires the consent information (Yes in S11-1), the consent information is stored in the storage unit 11 (S11-2), and the process proceeds to the step S12.

In the step S12, the acquisition unit 12 acquires, from one of the first server and the second server, the linkage target information that is to be subjected to information linkage. Then, the provision unit 13 determines whether the consent information is stored in the storage unit 11 (S13-1).

In a case where the consent information is stored in the storage unit 11 (Yes in S13-1), the provision unit 13 carries out the provision process for providing the linkage target information to the other of the first server and the second server (S13-2). In a case where the consent information is not stored in the storage unit 11 (No in S13-1), the provision unit 13 ends the process without carrying out the provision process for providing the linkage target information to the other of the first server and the second server.

<Effect of Information Processing Method>

As described above, according to the first information processing method in accordance with the first example embodiment, in a case where the consent information that corresponds to the user ID linkage is stored in the storage unit 11, the provision unit 13 carries out the provision process for providing the linkage target information to the other of the first server and the second server. This makes it possible to enable intersystem linkage for each combination between an EC website and a store or the like that is a receiving facility.

<Second Information Processing Apparatus 2 in Accordance with First Example Embodiment>

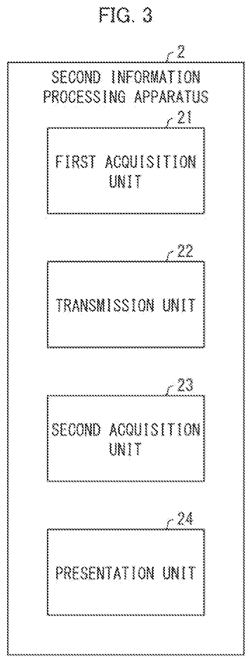

FIG. 3 is a block diagram illustrating an example configuration of a second information processing apparatus 2 in accordance with the first example embodiment of the present invention. The second information processing apparatus 2 in accordance with the first example embodiment includes a first acquisition unit 21, a transmission unit 22, a second acquisition unit 23, and a presentation unit 24 (see FIG. 3).

The first acquisition unit 21 is configured to achieve a first acquisition means in the first example embodiment. The transmission unit 22 is configured to achieve a transmission means in the first example embodiment. The second acquisition unit 23 is configured to achieve a second acquisition means in the first example embodiment. The presentation unit 24 is configured to achieve a presentation means in the first example embodiment.

The first acquisition unit 21 acquires, from a user, an instruction to purchase a product. The transmission unit 22 transmits a request to a linkage server that links the second information processing apparatus 2 with another server, for example to the first information processing apparatus 1. The second information processing apparatus 2 is, for example, a server that is provided on an EC website. The EC website is a concept including a website of, for example, a retail store at which a product is sold. The EC website includes websites of, for example, a supermarket and a drugstore.

The another server is, for example, a server that is provided on a store website. The store website is a concept including a website of a facility at which a product can be received. The store website includes websites of, for example, a convenience store, a delivery locker, a hospital, a supermarket, and a drugstore.

For example, the transmission unit 22 transmits, to the linkage server, a request for requesting the linkage target information. The linkage target information is, for example, delivery destination information that is information pertaining to a store (receivable place) at which the user is to receive a product. The linkage target information includes, for example, information such as a store name and a store address.

The second acquisition unit 23 acquires, from the linkage server, at least one receivable place at which the product is receivable and which is associated with second authentication information that is associated with first authentication information used in the second information processing apparatus 2 to authenticate the user.

The first authentication information is authentication information pertaining to the user and registered in the second information processing apparatus 2. Examples of the first authentication information include a user ID and a password. The second authentication information is authentication information registered in the another server, e.g., the server that is provided on the store website. Examples of the second authentication information include the user ID and the password.

The linkage server that has received, from the user, consent regarding the linkage between the first authentication information and the second authentication information (linkage between PD information pertaining to the user and managed by the second information processing apparatus 2 and PD information pertaining to the user and managed by the another server) provides the second information processing apparatus 2 with the at least one receivable place which is associated with the second authentication information.

The presentation unit 24 presents, to the user, presentation information including the at least one receivable place. For example, the presentation unit 24 transmits the presentation information to an information processing apparatus that is used by the user. By displaying the presentation information in a display unit of the information processing apparatus that is used by the user, the presentation information including the at least one receivable place can be presented to the user.

<Effect of Second Information Processing Apparatus 2>

As described above, according to the second information processing apparatus 2 in accordance with the first example embodiment, the second acquisition unit 23 acquires the at least one receivable place which is associated with the second authentication information that is associated with the first authentication information. This makes it possible to acquire, from the linkage server, PD information pertaining to the user and unmanaged by the second information processing apparatus 2.

<Flow of Information Processing Method Carried Out by Second Information Processing Apparatus 2>

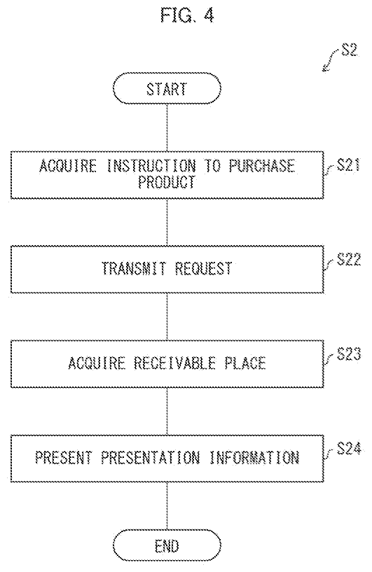

The following description discusses, with reference to FIG. 4, a flow of an information processing method carried out by the second information processing apparatus 2 configured as described above. FIG. 4 is a flowchart showing the flow of the information processing method. As illustrated in FIG. 4, an information processing method S2 includes steps S21 to S24.

First, the first acquisition unit 21 acquires, from a user, an instruction to purchase a product (S21). Then, the transmission unit 22 transmits a request to a linkage server that links the second information processing apparatus 2 with another server (S22). The second information processing apparatus 2 is, for example, a server that is provided on an EC website. The EC website is a concept including a website of, for example, a retail store at which a product is sold. The EC website includes websites of, for example, a supermarket and a drugstore.

Next, the second acquisition unit 23 acquires, from the linkage server, at least one receivable place which is associated with the second authentication information that is associated with the first authentication information used in the second information processing apparatus 2 to authenticate the user (S23).

Finally, the presentation unit 24 presents, to the user, the presentation information including the at least one receivable place (S24). For example, the presentation unit 24 transmits the presentation information to an information processing apparatus that is used by the user. By displaying the presentation information in a display unit of the information processing apparatus that is used by the user, the presentation information including the at least one receivable place can be presented to the user.

<Effect of Information Processing Method>

As described above, according to the information processing method carried out by the second information processing apparatus 2 in accordance with the first example embodiment, the second acquisition unit 23 acquires the at least one receivable place which is associated with the second authentication information that is associated with the first authentication information. This makes it possible to acquire, from the linkage server, the PD information pertaining to the user and unmanaged by the second information processing apparatus 2.

### Second Example Embodiment

A second example embodiment of the present invention will be described in detail with reference to the drawings. Note that members having functions identical to those of the respective members described in the first example embodiment are given respective identical reference numerals, and a description of those members is omitted as appropriate.

<ID Linkage Service in ID Linkage System>

The following description briefly discusses an ID linkage service in an ID linkage system in accordance with the second example embodiment of the present invention. On an EC website of a retail store that registers a user ID in the ID linkage service, it is possible to present, to a user, a receiving place that is a store (receiving facility) which uses an ID linkage function in the ID linkage service to register the user ID in the ID linkage service as in the case of the retail store (provided that the user has the user ID in both the retail store and the store).

A product purchased on the EC website of the retail store is delivered to the store (receiving facility) selected by the user. In a case where the user who has been notified by the retail store of completion of delivery visits the store (receiving facility) and presents an ID (a loyalty card, etc.), it can be confirmed that the user has purchased the product, so that the user can receive the product.

Distribution of information such as a shopping history of the user between the EC website and the receiving facility in accordance with agreement by the user enables the EC website and the receiving facility to carry out sales promotion measures (discounts for products, distribution of coupons, etc.) personalized to the user. As a secondary use case, implementation of functions of payment for purchase expenses at the store (receiving facility) and transfer of money from the store (receiving facility) to the retail store enables payment by proxy.

The ID linkage service is a service that integrates and manages the user ID which is for an end user and which is provided by each service provider. In a case where the user uses the ID linkage service, the user ID that is possessed by the user is held and managed. Upon receiving an inquiry, made with use of the user ID, from the user or a business operator serving as a provider of the user ID, the ID linkage service that is required to provide information notifies, in accordance with consent of the user, a state of user ID linkage and how the user uses a business operator with which the user ID is linked.

A configuration such that it is notified how the user uses the business operator with which the user ID is linked is originally a way of promoting distribution of PD of the user. The PD is managed by each service provider in accordance with the user ID that the each service provider has issued to the user. The PD that is understood by the provider of the user ID is divided into data silos. Specifically, the above configuration includes a configuration such that PD associated with the user ID which is provided by each service provider via the ID linkage service can be shared via the linked user ID under user agreement/consent.

The ID linkage service enables each business operator to acquire not only PD that is associated with a user ID provided by the each business operator, but also PD that is obtained by a business operator serving as a provider of another user ID which is linked with the user ID.

Note that the PD may be transmitted and received in such a manner that during user ID linkage, an end user sets the scope of disclosure of PD information and gives distribution consent so as to distribute the PD information within the scope of the distribution consent even between linked ID providers.

<Example Configuration of ID Linkage System in Accordance with Second Example Embodiment>

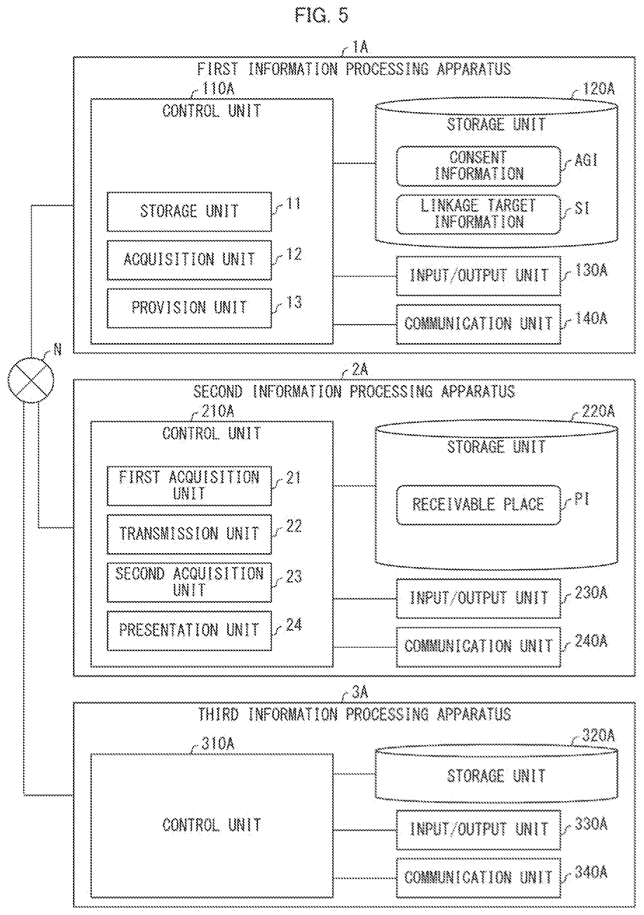

FIG. 5 is a diagram illustrating a configuration of the ID linkage system in accordance with the second example embodiment of the present invention. The ID linkage system in accordance with the second example embodiment includes a first information processing apparatus 1A, a second information processing apparatus 2A, and a third information processing apparatus 3, which are connected via a network N so as to be capable of transmitting and receiving information. Note here that the network has a specific configuration which does not limit the second example embodiment. Examples of the network include a wireless local area network (LAN), a wired LAN, a wide area network (WAN), a public network, a mobile data communication network, and a combination of these networks.

<Example Configuration of First Information Processing Apparatus 1A>

The first information processing apparatus 1A is an information processing apparatus such as a server for carrying out the ID linkage service. The second information processing apparatus 2A is an information processing apparatus such as a server provided on an EC website. The third information processing apparatus 3A is an information processing apparatus such as a server provided on a store website.

The first information processing apparatus 1A includes a control unit 110A, a storage unit 120A, an input/output unit 130A, and a communication unit 140A. The control unit 110A further includes a storage unit 11, an acquisition unit 12, and a provision unit 13.

The storage unit 120A stores consent information AGI and linkage target information SI. The consent information AGI is information indicating that the user has agreed to linkage between (a) PD information pertaining to the user and managed by the second information processing apparatus 2A that is provided on the EC website and (b) PD information pertaining to the user and managed by the third information processing apparatus 3A that is provided on the store website.

The linkage target information SI includes purchase information and delivery destination specifying information. The purchase information is information pertaining to a product that the user has purchased on the EC website. The purchase information includes, for example, a purchased product, a quantity, a unit price, purchase date and time, and a payment method. The delivery destination specifying information is information pertaining to a store at which the user is to receive a product. The delivery destination includes, for example, information such as a store name, a store address, receipt date and time, a payment method, sex of the user, and a user age bracket.

The input/output unit 130A is constituted by, for example, a keyboard, a pointing device such as a mouse, and a display for displaying, for example, the consent information AGI and the linkage target information SI. For example, the input/output unit 130A inputs an instruction from, for example, a manager of the first information processing apparatus 1A and presents information to, for example, the manager.

The communication unit 140A can transmit and receive information to and from the second information processing apparatus 2A and the third information processing apparatus 3A via the network N.

The acquisition unit 12 that has received, via the communication unit 140A, information indicating consent of the user regarding user ID linkage between the second information processing apparatus 2A that is provided on the EC website and the third information processing apparatus 3A that is provided on the store website stores the information as the consent information AGI in the storage unit 120A.

The acquisition unit 12 that has received, via the communication unit 140A from one of the second information processing apparatus 2A that is provided on the EC website and the third information processing apparatus 3A that is provided on the store website, linkage target information that is to be subjected to information linkage stores the linkage target information as the linkage target information SI in the storage unit 120A.

The acquisition unit 12 acquires (i) first authentication information that is used by a first server (the second information processing apparatus 2A that is provided on the EC website) to authenticate the user and (ii) second authentication information that is used by a second server (the third information processing apparatus 3A that is provided on the store website) to authenticate the user. The storage unit 120A stores the first authentication information, the second authentication information, and the linkage target information SI in association with each other.

In a case where the acquisition unit 12 acquires a request for provision of the linkage target information SI from one of the first server and the second server, and the consent information AGI is stored in the storage unit 120A, the provision unit 13 carries out a provision process for providing the linkage target information SI to the one of the first server and the second server.

The provision unit 13 may be configured to filter the linkage target information with reference to activity information of the user and provide the filtered linkage target information. For example, a terminal apparatus that is used by the user transmits global positioning system (GPS) information to the first information processing apparatus 1A, and notifies the first information processing apparatus 1A of an activity range (activity log data) of the user.

The provision unit 13 that receives the activity log data of the user via the communication unit 140A sequentially stores the activity log data in the storage unit 120A. The provision unit 13 may be configured to narrow the linkage target information (delivery destination information) with reference to the activity range of the user, the activity range being indicated by the activity log data that is stored in the storage unit 120A, and provide the second information processing apparatus 2A with the narrowed delivery destination information.

For example, the provision unit 13 may acquire, from the activity log data, information that the user is now at home and that on a weekday, the user is to go to work from now on, and add, to narrowing criteria, an area including a destination to which the user goes to work. That is, the provision unit 13 may be configured to filter the linkage target information with reference to workplace address information of the user in a case where the workplace address information is included in information managed by the first information processing apparatus 1A.

The provision unit 13 may further carry out narrowing with an area including a business operator that can enjoy a great advantage by a coupon service added as another filtering condition. This enables a business operator to additionally aim at attracting more users.

<Example Configuration of Second Information Processing Apparatus 2A>

The second information processing apparatus 2A includes a control unit 210A, a storage unit 220A, an input/output unit 230A, and a communication unit 240A. The control unit 210A further includes a first acquisition unit 21, a transmission unit 22, a second acquisition unit 23, and a presentation unit 24.

The storage unit 220A stores a receivable place PI. The receivable place PI is information pertaining to a place of a store at which a user can receive a product that the user has purchased. The receivable place PI includes, for example, information such as a store name and a store address.

The input/output unit 230A is constituted by, for example, a keyboard, a pointing device such as a mouse, and a display for displaying, for example, the receivable place. For example, the input/output unit 230A inputs an instruction from, for example, a manager of the second information processing apparatus 2A and presents information to, for example, the manager.

The communication unit 240A can transmit and receive information to and from the first information processing apparatus 1A and the third information processing apparatus 3A via the network N.

In a case where the first acquisition unit 21 receives, via the communication unit 240A, an instruction from the user to purchase a product, the transmission unit 22 transmits a request to a linkage server that links the second information processing apparatus 2A with another server, for example to the first information processing apparatus 1A. The another server is, for example, the third information processing apparatus 3A that is provided on the store website.

The second acquisition unit 23 receives, from the first information processing apparatus 1A via the communication unit 240A, at least one receivable place at which the product is receivable and which is associated with second authentication information that is associated with first authentication information used in the second information processing apparatus 2A to authenticate the user.

The presentation unit 24 presents, to the user, presentation information including the at least one receivable place. For example, the presentation unit 24 transmits the presentation information via the communication unit 240A to a terminal apparatus that is used by the user. By displaying the presentation information in the terminal apparatus that is used by the user, the presentation information including the at least one receivable place can be presented to the user.

<Example Configuration of Third Information Processing Apparatus 3A>

The third information processing apparatus 3A includes a control unit 310A, a storage unit 320A, an input/output unit 330A, and a communication unit 340A.

The storage unit 320A stores various pieces of information handled by the third information processing apparatus 3A. The communication unit 340A can transmit and receive information to and from the first information processing apparatus 1A and the second information processing apparatus 2A via the network N.

The input/output unit 330A is constituted by, for example, a keyboard, a pointing device such as a mouse, and a display for displaying, for example, the receivable place. For example, the input/output unit 330A inputs an instruction from, for example, a manager of the third information processing apparatus 3A and presents information to, for example, the manager.

The control unit 310A that has received, from the first information processing apparatus 1A via the communication unit 340A, a request for provision of the at least one receivable place that is associated with the second authentication information transmits, to the first information processing apparatus 1 via the communication unit 340A and the network N, the at least one receivable place that is associated with the second authentication information.

The control unit 310A transmits and receives information to and from the first information processing apparatus 1A or the second information processing apparatus 2A via the network N and the communication unit 340A in a case where the user receives the product. Note that details of a process carried out by the third information processing apparatus 3A will be described later.

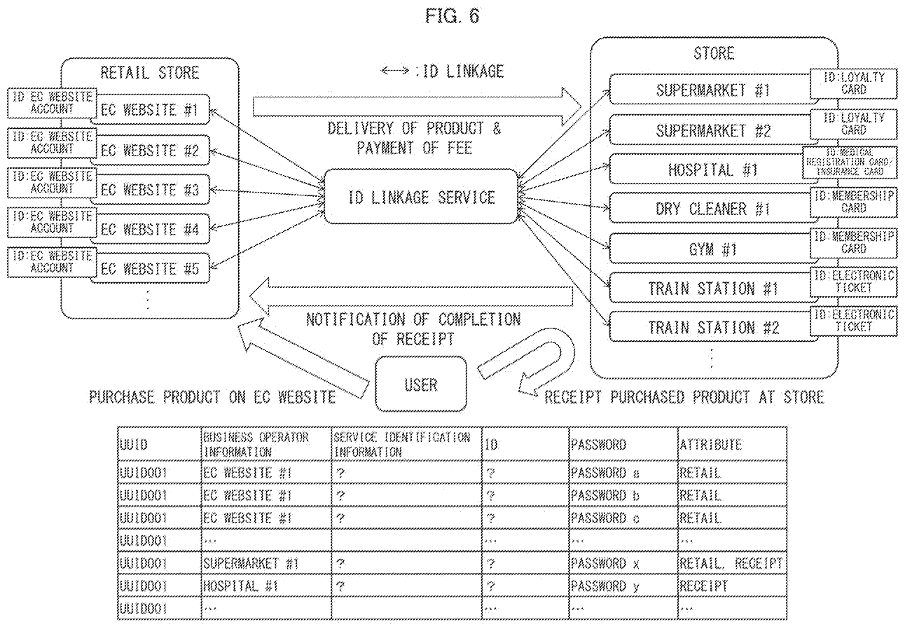

FIG. 6 is a view for describing the ID linkage service. The ID linkage service assigns a service provision attribute of a provider to a user ID group so as to manage a user ID (see an upper diagram in FIG. 6). The following description assumes that there are the following two types of businesses: a retail business (retail store) and a product transfer business (store). Note that for a single user ID, only one of the two types may be set or the two types may be set.

Note also that the above businesses need not be main businesses of operators thereof. It is assumed, for example, that a user ID for a hospital is assigned not only an attribute of a medical business but also an attribute of a transfer business (store).

In the upper diagram in FIG. 6, user ID groups possessed by a certain user are managed by the ID linkage service. Among the user ID groups, user ID groups having a retail business attribute are illustrated on the left side of the upper diagram in FIG. 6, and user ID groups having a transfer business attribute are illustrated on the right side of the upper diagram in FIG. 6. A user ID that is used by the certain user to, for example, purchase a product on an EC website #1 is hereinafter discussed as a user ID_EC-1. Note that a case is illustrated where a website account is used as a user ID having the retail business attribute, and a loyalty card, a medical registration card/insurance card, a membership card, and an electronic ticket are each used as a user ID having the transfer business attribute.

In a case where the user uses the user ID_EC-1 to log in to the EC website #1 and purchase the product, an operator of the EC website #1 uses the user ID_EC-1 to request receiving destination candidate information from the ID linkage service (first information processing apparatus 1A). Here, the ID linkage service extracts, in particular, a user ID group having a receiving destination attribute among the linked user ID groups associated with the user ID_EC-1.

In the upper diagram in FIG. 6, in a case where the user ID group having the receiving destination attribute has seven types of user IDs as illustrated on the right side of the upper diagram in FIG. 6, the ID linkage service notifies the operator of the EC website #1 of some or all of the seven types of user IDs. Note here that the above-described process for filtering the linkage target information can be used to notify the operator of the EC website #1 of some of the seven types of user IDs.

A lower diagram in FIG. 6 is a diagram for describing the user ID linkage in the ID linkage service. A universally unique identifier (UUID) is identification information for allowing the ID linkage system to uniquely identify a target user. Pieces of information UUID of which is the same “UUID001” are associated with each other.

The pieces of information each have information such as business operator information, a password, and an attribute. It is shown, for example, that the EC website #1 has a password “a” and an attribute “RETAIL”. As illustrated in the lower diagram in FIG. 6, it is shown that, in a case where user IDs of the EC website #1, a supermarket #1, and a hospital #1 are linked, “SUPERMARKET #1” and “HOSPITAL #1” can be listed as candidates for a receiving place at which a product that the user has purchased on the EC website #1 is to be received.

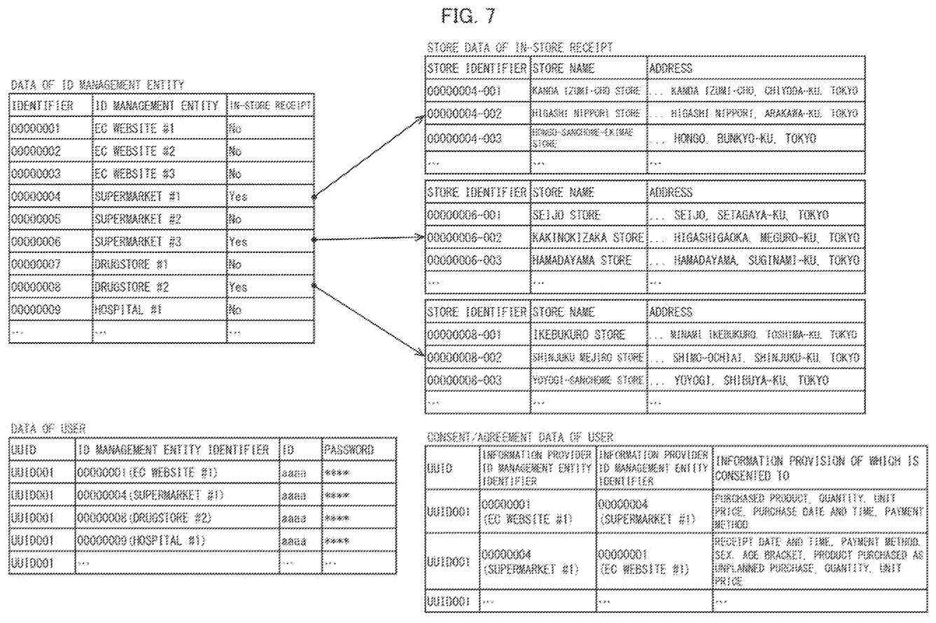

FIG. 7 is a view illustrating an example of a data structure stored in the storage unit 120A of the first information processing apparatus 1A. An upper left diagram in FIG. 7 illustrates data of an ID management entity. It is shown, for example, that in-store receipt is unfeasible in a case where the ID management entity is the EC website #1 and that in-store receipt is feasible in a case where the ID management entity is the supermarket #1.

An upper right diagram in FIG. 7 illustrates data concerning stores at which in-store receipt is feasible. For example, in a case where the ID management entity is the supermarket #1, names of a plurality of stores at which in-store receipt is feasible and respective addresses of the plurality of stores are listed.

A lower left diagram in FIG. 7 illustrates data concerning a user. For each UUID, an ID management entity identifier, an ID, and a password are listed. For example, as UUID001, the EC website #1, the supermarket #1, a drugstore #2, and the hospital #1 are listed.

A lower right diagram in FIG. 7 illustrates consent/agreement data of the user. For each UUID, an information provider ID management entity identifier, an information recipient ID management entity identifier, and information provision of which is consented to are listed. It is shown, for example, that the user consents to linkage between the EC website #1 and the supermarket #1.

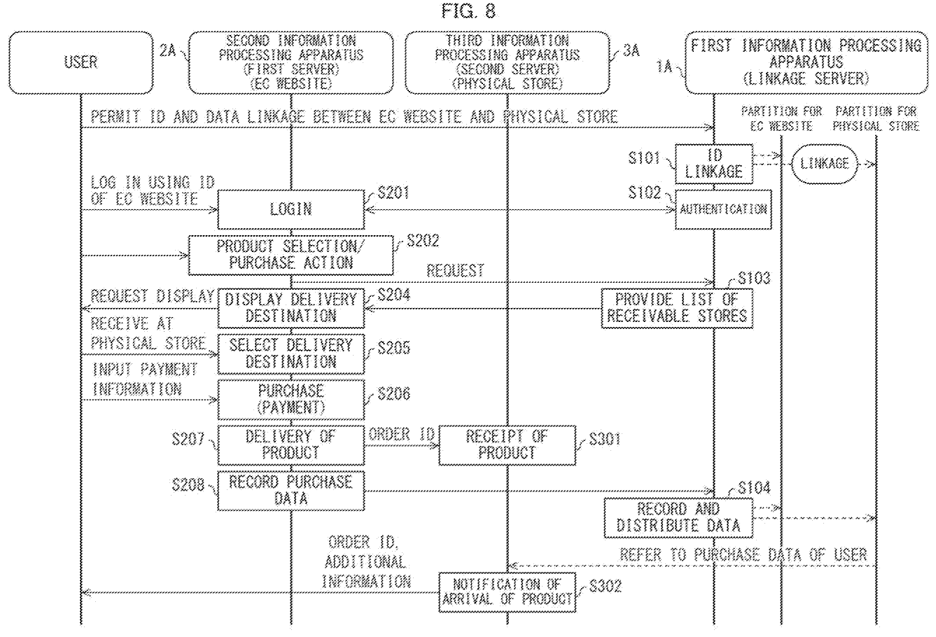

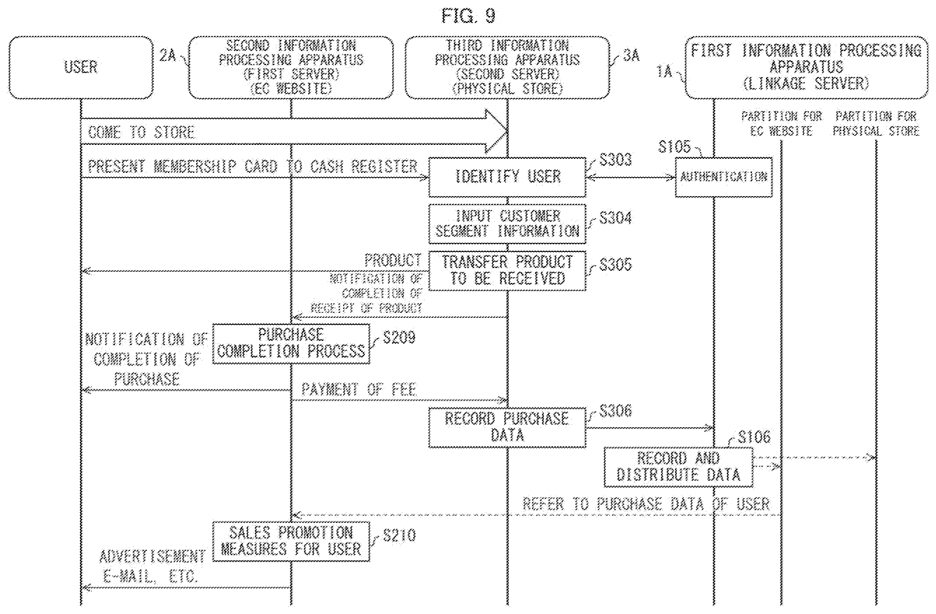

FIGS. 8 and 9 are sequence diagrams each showing a flow of an information processing method carried out by the ID linkage system in accordance with the second example embodiment of the present invention. As illustrated in FIGS. 8 and 9, the information processing method includes steps S101 to S106 that are a procedure through which the first information processing apparatus 1A carries out a process, steps S201 to S210 that are a procedure through which the second information processing apparatus 2A carries out a process, and steps S301 to S306 that are a procedure through which the third information processing apparatus 3A carries out a process.

FIGS. 8 and 9 illustrate a case where a user possesses “user ID_EC-B” issued by an EC website #B and “user ID_Chain-C” issued by a supermarket #C, and agrees in advance to ID linkage between the EC website #B and the supermarket #C. FIGS. 8 and 9 also illustrate a case where the second information processing apparatus 2A is provided on the EC website #B and the third information processing apparatus 3A is provided in the supermarket #C.

First, the first information processing apparatus 1A that has received, from a terminal apparatus of the user, permission for ID linkage and data linkage between the EC website and a physical store stores the consent information AGI and the linkage target information SI in respective corresponding regions (a partition for the EC website and a partition for the physical store) of the storage unit 120A so as to carry out the ID linkage (S101).

Next, in a case where the terminal apparatus of the user uses an ID of the EC website #B to log in, the second information processing apparatus 2A corresponding to the EC website #B requests login authentication from the first information processing apparatus 1A. In a case where the first information processing apparatus 1A carries out login authentication and permits login (S102), the second information processing apparatus 2A carries out a login process (S201).

Subsequently, in response to an action from the terminal apparatus of the user to select and purchase a product, the second information processing apparatus 2A carries out a process for selecting and purchasing the product, and addresses, to the first information processing apparatus 1A, a request for a list of stores at which the product is receivable (S202).

The request includes a request from the first server (second information processing apparatus 2A), and the linkage target information SI that is provided by the provision unit 13 includes at least one receivable place at which a product that the user has purchased via a sales website provided by the first server is receivable and which is associated with the second authentication information.

Specifically, the first information processing apparatus 1A that has received, from the second information processing apparatus 2A, the request for the list of stores at which the product is receivable uses the user ID of the EC website #B to search for the consent information AGI and the linkage target information SI that are stored in the storage unit 120A, determine a state of the user ID linkage, and generate the list of stores at which the product is receivable. The first information processing apparatus 1A provides the second information processing apparatus 2A with the list of stores at which the product is receivable (S103). For a store at which the product is receivable, only an ID group an attribute of which is provision by a receiving destination may be extracted from among linked ID groups.

Next, the second information processing apparatus 2A that has received the list of stores at which the product is receivable transfers, to the terminal apparatus of the user, the list of stores (delivery destinations) at which the product is receivable, and requests the terminal apparatus of the user to display the lists (S204). Note here that the list of stores at which the product is receivable includes, in a case where there is a physical store that is linked to the user ID of the EC website #B, information pertaining to the physical store and information pertaining to a candidate physical store. The list includes, in a case where there is no physical store that is linked to the user ID of the EC website #B, only the information pertaining to the candidate physical store. The candidate physical store is, for example, a physical store that is close to an address of the user and that is not subjected to ID linkage.

Subsequently, the user refers to the list of stores at which the product is receivable, the list being displayed in the terminal apparatus. The user who wishes to receive the product at the physical store selects a store (delivery destination) at which the user is to receive the product, and transmits the store to the second information processing apparatus 2A. The second information processing apparatus 2A that has received, from the terminal apparatus of the user, the store (delivery destination) at which the user is to receive the product, carries out a process for selecting the delivery destination (S205).

In a case where the user inputs payment information to the terminal apparatus, the second information processing apparatus 2A receives the payment information from the terminal apparatus and carries out a process for purchasing (paying for) the product (S206). Then, the second information processing apparatus 2A requests delivery of the product by transmitting, to the physical store (third information processing apparatus 3A) that has been selected by the user, an order ID in which the user ID is used (S207).

The second information processing apparatus 2A transmits such purchase data to the first information processing apparatus 1A (S208). The first information processing apparatus 1A receives and records the purchase data, and registers the purchase data as data for the EC website #B and data for the supermarket #C in a region to which each business operator can refer (S104).

In a case where the product delivered has arrived at the supermarket #C (S301), the third information processing apparatus 3A notifies the user of arrival of the product by sending, to the user, not only the order ID but also the purchase data of the user, the purchase data having been distributed from the EC website #B and being recorded in the first information processing apparatus 1A, and additional information (a recommended product for an unplanned purchase, a discount coupon for a related product, a vacant time period, etc.) created from, for example, existing data of the user at the supermarket #C (S302).

In a case where the user visits the physical store and presents a membership card or the like to a cash register, the third information processing apparatus 3A addresses an authentication request to the first information processing apparatus 1A (S303). The first information processing apparatus 1A that has received the authentication request from the third information processing apparatus 3A transmits a result of authentication of the user to the third information processing apparatus 3A (S105).

After an authentication process is completed, a clerk or the like at the physical store visually observes the user and inputs customer segment data to the third information processing apparatus 3A (S304). The customer segment data thus input is reliable to a certain degree. This is because the customer segment data is input by a third party, i.e., the clerk or the like at the physical store, whereas data input by the user during membership registration is input by the user itself.

Next, the clerk or the like at the physical store transfers the purchased product (transfers a product to be received) and inputs completion of transfer to the third information processing apparatus 3A. In a case where the third information processing apparatus 3A notifies the second information processing apparatus 2A of completion of receipt of the product, the second information processing apparatus 2A carries out a purchase completion process (S209). Specifically, the second information processing apparatus 2A notifies the terminal apparatus of the user of completion of purchase and pays a fee in exchange for a receiving place provision service to the third information processing apparatus.

The request includes a request from the first server (second information processing apparatus 2A), and the linkage target information SI that is provided by the provision unit 13 may include the purchase data of the user at a place at which the user received the product that the user had purchased via the sales website provided by the first server.

Specifically, the third information processing apparatus 3A receives payment of the fee from the second information processing apparatus 2A and transmits the purchase data of the user to the first information processing apparatus 1A (S306). The first information processing apparatus 1A receives and records the purchase data, and registers the purchase data as the data for the EC website #B and the data for the supermarket #C in the region to which each business operator can refer (S106).

Thus, after this, the second information processing apparatus 2A can access the first information processing apparatus 1A and refer to the purchase data, so that sales promotion measures (transmission of an advertisement e-mail, etc.) for the user can be considered by utilizing the purchase data (S210).

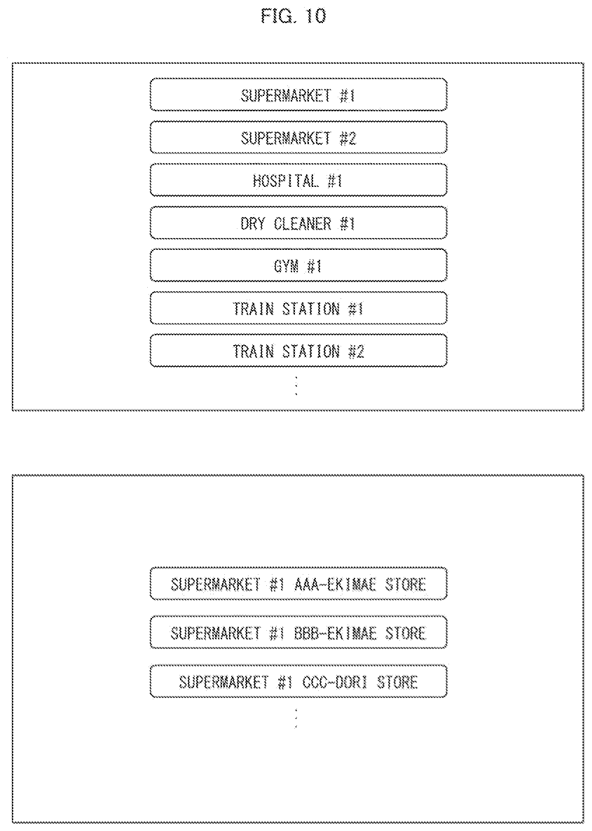

FIG. 10 is a view illustrating an example of a receiving facility displayed in the terminal apparatus of the user. As illustrated in an upper diagram in FIG. 10, information pertaining to, for example, the supermarkets #1 and #2, the hospital #1, and a dry cleaner #1 is displayed. For example, in a case where the supermarket #1 is selected by the user, more detailed stores of the supermarket #1 are displayed in the terminal apparatus of the user as illustrated in a lower diagram in FIG. 10.

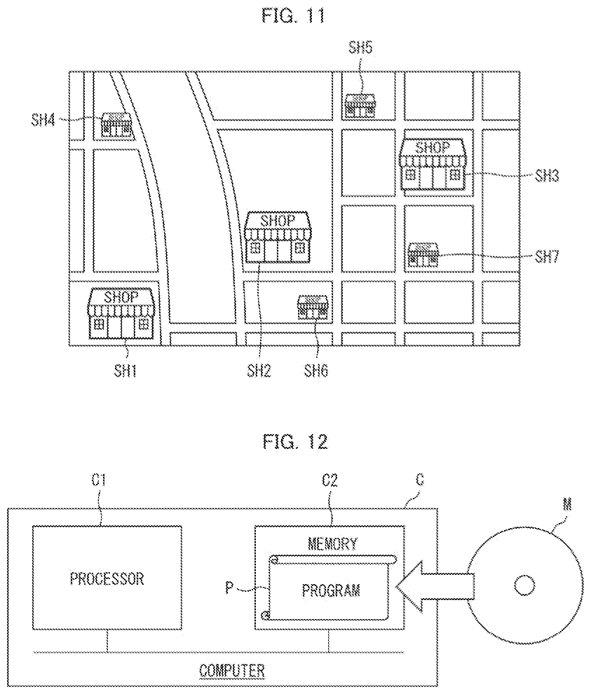

FIG. 11 is a view illustrating an example of a receiving facility (presentation information) displayed on a map. At least one receivable place that is associated with the second authentication information and at least one receivable place that is unassociated with the second authentication information may be included in the presentation information in such a manner as to be distinguishable from each other. For example, as illustrated in FIG. 11, stores SH1 to SH7 are displayed on the map, a store that is subjected to ID linkage is displayed (highlighted) in a large size, and a store that is not subjected to ID linkage is displayed in a small size.

As described earlier, the first information processing apparatus 1A that is notified by the terminal apparatus of the user of GPS information which is narrowed with reference to a sphere of activity of a purchaser may be configured to carry out filtering, in consideration of the activity log data of the user, with respect to the user who is highly subjected to ID linkage. For example, the first information processing apparatus 1A may acquire, from an activity log, information that the user is now at home and that on a weekday, the user is to go to work from now on, and add, to the narrowing criteria, an area including a destination to which the user goes to work. In other words, the workplace address information that is included in information managed by the ID linkage service may be reflected in the ID linkage service.

Narrowing may be carried out with an area including a business operator that can enjoy a great advantage by a coupon service added as another filtering condition. This enables a business operator to additionally aim at attracting more users.

Assuming a case where there is no linked ID, the first information processing apparatus 1A may notify the user who is not subjected to ID linkage of a specified candidate that is a receiving destination (including a site of the store) with which the first information processing apparatus 1A cooperates by default. In so doing, in order to promote linkage, the first information processing apparatus 1A may notify the user of a receiving destination candidate that can be specified when already linked with the first information processing apparatus 1A. In a case where the user who is notified of the receiving destination candidate wishes ID linkage, a flow of a process for leading the user to a linkage process may be provided.

<Effect of ID Linkage System>

As described above, according to the ID linkage system in accordance with the second example embodiment, the storage unit 120A stores the first authentication information, the second authentication information, and the linkage target information SI in association with each other. This enables the acquisition unit 12 to use the first authentication information or the second authentication information to easily acquire the linkage target information SI.

Furthermore, in a case where the consent information AGI is stored in the storage unit 120A, the provision unit 13 carries out the provision process for providing the linkage target information SI to the one of the first server and the second server. This enables the first server or the second server to easily acquire the linkage target information SI.

Moreover, the provision unit 13 filters the linkage target information with reference to the activity information of the user and provides the filtered linkage target information. This enables the user to acquire more useful linkage target information.

Further, the linkage target information SI that is provided by the provision unit 13 includes at least one receivable place at which a product that the user has purchased via a sales website provided by the first server is receivable and which is associated with the second authentication information. This enables the user to easily select a receiving place at which the product is to be received.

In addition, the linkage target information SI that is provided by the provision unit 13 includes purchase data of the user at a place at which the user received the product that the user had purchased via the sales website provided by the first server. This enables each business operator to refer to information such as a product that the user has purchased at the receiving place (store) as an unplanned purchase, a quantity, and a unit price.

Furthermore, at least one receivable place that is associated with the second authentication information and at least one receivable place that is unassociated with the second authentication information are included in the presentation information in such a manner as to be distinguishable from each other. This enables the user to easily identify a receivable place that is desired by the user (subjected to ID linkage).

[Software Implementation Example]

Some or all of functions of the information processing apparatus 1, 1A, 2, 2A, 3, or 3A can be realized by hardware provided in an integrated circuit (IC chip) or the like or can be alternatively realized by software.

In the latter case, the information processing apparatus 1, 1A, 2, 2A, 3, or 3A is realized by, for example, a computer that executes instructions of a program that is software realizing the foregoing functions. FIG. 12 illustrates an example of such a computer (hereinafter referred to as a “computer C”). The computer C includes at least one processor C1 and at least one memory C2. The at least one memory C2 stores a program P for causing the computer C to operate as the information processing apparatus 1, 1A, 2, 2A, 3, or 3A. In the computer C, the at least one processor C1 reads and executes the program P stored in the at least one memory C2, so that the functions of the information processing apparatus 1, 1A, 2, 2A, 3, or 3A are realized.

Examples of the at least one processor C1 encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the at least one memory C2 encompass a flash memory, a hard disk drive (HDD), a solid state drive (SSD), and a combination thereof.

Note that the computer C may further include a RAM in which the program P is to be loaded while being executed and in which various kinds of data are to be temporarily stored. The computer C may further include a communication interface through which data is to be transmitted and received between the computer C and at least one other apparatus. The computer C may further include an input/output interface through which an input/output device(s) such as a keyboard, a mouse, a display and/or a printer is/are to be connected to the computer C.

The program P can be recorded in a non-transitory, tangible storage medium M capable of being read by the computer C. Examples of such a storage medium M encompass a tape, a disk, a card, a semiconductor memory, and a programmable logic circuit. The computer C can acquire the program P via the storage medium M. The program P can alternatively be transmitted via a transmission medium. Examples of such a transmission medium encompass a communication network and a broadcast wave. The computer C can alternatively acquire the program P via the transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as, but not limited to, the following supplementary notes.

(Supplementary Note 1)

An information processing apparatus including:
a storage means that stores consent information in a case where the consent information has been acquired, the consent information indicating consent of a user regarding linkage between a first server and a second server;
an acquisition means that acquires, from one of the first server and the second server, linkage target information that is to be subjected to information linkage; and
a provision means that carries out, in a case where the consent information is stored in the storage means, a provision process for providing the linkage target information to the other of the first server and the second server and that does not carry out, in a case where the consent information is not stored in the storage means, the provision process for providing the linkage target information to the other of the first server and the second server is not carried out.

(Supplementary Note 2)

The information processing apparatus according to Supplementary note 1, wherein
the acquisition means acquires first authentication information used by the first server to authenticate the user and second authentication information used by the second server to authenticate the user are acquired, and
the storage means stores the first authentication information, the second authentication information, and the linkage target information in association with each other.

(Supplementary Note 3)

The information processing apparatus according to Supplementary note 2, wherein
in a case where the acquisition means acquires a request for provision of the linkage target information from one of the first server and the second server and the consent information is stored in the storage means,
the provision means carries out a process for providing the linkage target information to the one of the first server and the second server.

(Supplementary Note 4)

The information processing apparatus according to Supplementary note 3, wherein
the provision means filters the linkage target information with reference to activity information of the user and provides the filtered linkage target information.

(Supplementary Note 5)

The information processing apparatus according to Supplementary note 3 or 4, wherein
the request includes a request from the first server, and
the linkage target information provided by the provision means includes at least one receivable place at which a product that the user has purchased via a sales website provided by the first server is receivable and which is associated with the second authentication information.

(Supplementary Note 6)

The information processing apparatus according to Supplementary note 3, wherein
the request includes a request from the first server, and
the linkage target information provided by the provision means includes purchase data of the user at a place at which the user received a product that the user had purchased via a sales website provided by the first server.

(Supplementary Note 7)

An information processing apparatus including:
a first acquisition means that acquires, from a user, an instruction to purchase a product;
a transmission means that transmits a request to a linkage server that links the information processing apparatus with another server;
a second acquisition means that acquires, from the linkage server, at least one receivable place at which the product is receivable and which is associated with second authentication information that is associated with first authentication information used in the information processing apparatus to authenticate the user; and
a presentation means that presents, to the user, presentation information including the at least one receivable place.

(Supplementary Note 8)

The information processing apparatus according to Supplementary note 7, wherein
the presentation information includes:
   the at least one receivable place that is associated with the second authentication information; and
   the at least one receivable place that is unassociated with the second authentication information in such a manner as to be distinguishable from each other.

(Supplementary Note 9)

An information processing method including:
storing consent information in a storage means in a case where the consent information has been acquired, the consent information indicating consent of a user regarding linkage between a first server and a second server; and
acquiring, from one of the first server and the second server, linkage target information that is to be subjected to information linkage, wherein
a provision process for providing the linkage target information to the other of the first server and the second server is carried out in a case where the consent information is stored in the storage means, and the provision process for providing the linkage target information to the other of the first server and the second server is not carried out in a case where the consent information is not stored in the storage means.

(Supplementary Note 10)

An information processing method including:
acquiring, from a user, an instruction to purchase a product;
transmitting a request to a linkage server that links an information processing apparatus with another server;
acquiring, from the linkage server, at least one receivable place at which the product is receivable and which is associated with second authentication information that is associated with first authentication information used in the information processing apparatus to authenticate the user; and
presenting, to the user, presentation information including the at least one receivable place.

(Supplementary Note 11)

A program for causing a computer to carry out:
a storage process for storing consent information in a storage means in a case where the consent information has been acquired, the consent information indicating consent of a user regarding linkage between a first server and a second server; and
an acquisition process for acquiring, from one of the first server and the second server, linkage target information that is to be subjected to information linkage,
the computer carrying out, in a case where the consent information is stored in the storage means, a provision process for providing the linkage target information to the other of the first server and the second server, and not carrying out, in a case where the consent information is not stored in the storage means, the provision process for providing the linkage target information to the other of the first server and the second server.

(Supplementary Note 12)

A program for causing a computer to carry out:
an acquisition process for acquiring, from a user, an instruction to purchase a product;
a transmission process for transmitting a request to a linkage server that links an information processing apparatus with another server;
an acquisition process for acquiring, from the linkage server, at least one receivable place at which the product is receivable and which is associated with second authentication information that is associated with first authentication information used in the information processing apparatus to authenticate the user; and
a presentation process for presenting, to the user, presentation information including the at least one receivable place.

(Supplementary Note 13)

An information processing apparatus including:
a storage means that stores consent information in a case where the consent information has been acquired, the consent information indicating consent of a user regarding linkage between a first server and a second server;
an acquisition means that acquires, from one of the first server and the second server, linkage target information that is to be subjected to information linkage; and
a determination means that, in a case where the consent information is stored in the storage means, carries out a process for determining, in accordance with the consent information, whether it is proper to provide the linkage target information to the other of the first server and the second server.

(Supplementary Note 14)

An information processing apparatus including at least one processor, the at least one processor carrying out:
a storage process for storing consent information in a storage means in a case where the consent information has been acquired, the consent information indicating consent of a user regarding linkage between a first server and a second server; and
an acquisition process for acquiring, from one of the first server and the second server, linkage target information that is to be subjected to information linkage,
the at least one processor carrying out, in a case where the consent information is stored in the storage means, a provision process for providing the linkage target information to the other of the first server and the second server, and not carrying out, in a case where the consent information is not stored in the storage means, the provision process for providing the linkage target information to the other of the first server and the second server.

Note that the information processing apparatus may further include a memory, which may store a program for causing the at least one processor to carry out the storage process, the acquisition process, and the provision process. Furthermore, the program may be recorded in a non-transitory, tangible computer-readable storage medium.

(Supplementary Note 15)

An information processing apparatus including at least one processor, the at least one processor carrying out:
an acquisition process for acquiring, from a user, an instruction to purchase a product;
a transmission process for transmitting a request to a linkage server that links the information processing apparatus with another server;
an acquisition process for acquiring, from the linkage server, at least one receivable place at which the product is receivable and which is associated with second authentication information that is associated with first authentication information used in the information processing apparatus to authenticate the user; and
a presentation process for presenting, to the user, presentation information including the at least one receivable place.

Note that the information processing apparatus may further include a memory, which may store a program for causing the at least one processor to carry out the acquisition process for acquiring the instruction to purchase the product, the transmission process, the acquisition process for acquiring the at least one receivable place at which the product is receivable, and the presentation process. Furthermore, the program may be recorded in a non-transitory, tangible computer-readable storage medium.

### REFERENCE SIGNS LIST

1, 1A First information processing apparatus
2, 2A Second information processing apparatus
3, 3A Third information processing apparatus
11 Storage unit
12 Acquisition unit
13 Provision unit
21 First acquisition unit
22 Transmission unit
23 Second acquisition unit
24 Presentation unit
110A, 210A, 310A Control unit
120A, 220A, 320A Storage unit
130A, 230A, 330A Input/output unit
140A, 240A, 340A Communication unit

1. An information processing apparatus comprising at least one processor, the at least one processor carrying out:
a storage process for storing consent information in a storage unit in a case where the consent information has been acquired, the consent information indicating consent of a user regarding linkage between a first server and a second server; and
an acquisition process for acquiring, from one of the first server and the second server, linkage target information that is to be subjected to information linkage,
the at least one processor carrying out, in a case where the consent information is stored in the storage unit, a provision process for providing the linkage target information to the other of the first server and the second server, and not carrying out, in a case where the consent information is not stored in the storage unit, the provision process for providing the linkage target information to the other of the first server and the second server.

2. The information processing apparatus according to claim 1, wherein
in the acquisition process, the at least one processor acquires first authentication information used by the first server to authenticate the user and second authentication information used by the second server to authenticate the user, and
in the storage process, the at least one processor stores the first authentication information, the second authentication information, and the linkage target information in the storage unit in association with each other.

3. The information processing apparatus according to claim 2, wherein
in the acquisition process, in a case where the at least one processor acquires a request for provision of the linkage target information from one of the first server and the second server and the consent information is stored in the storage unit,
the at least one processor carries out, in the provision process, a process for providing the linkage target information to the one of the first server and the second server.

4. The information processing apparatus according to claim 3, wherein in the provision process, the at least one processor filters the linkage target information with reference to activity information of the user and provides the filtered linkage target information.

5. The information processing apparatus according to claim 3, wherein
the request includes a request from the first server, and
the provided linkage target information includes at least one receivable place at which a product that the user has purchased via a sales website provided by the first server is receivable and which is associated with the second authentication information.

6. The information processing apparatus according to claim 3, wherein
the request includes a request from the first server, and
the provided linkage target information includes purchase data of the user at a place at which the user received a product that the user had purchased via a sales website provided by the first server.

7. An information processing apparatus comprising at least one processor, the at least one processor carrying out:
an acquisition process for acquiring, from a user, an instruction to purchase a product;
a transmission process for transmitting a request to a linkage server that links the information processing apparatus with another server;
an acquisition process for acquiring, from the linkage server, at least one receivable place at which the product is receivable and which is associated with second authentication information that is associated with first authentication information used in the information processing apparatus to authenticate the user; and
a presentation process for presenting, to the user, presentation information including the at least one receivable place.

8. The information processing apparatus according to claim 7, wherein
the presentation information includes:
the at least one receivable place that is associated with the second authentication information; and
the at least one receivable place that is unassociated with the second authentication information in such a manner as to be distinguishable from each other.

9. An information processing method comprising:
storing consent information in a storage unit in a case where the consent information has been acquired, the consent information indicating consent of a user regarding linkage between a first server and a second server; and
acquiring, from one of the first server and the second server, linkage target information that is to be subjected to information linkage, wherein
a provision process for providing the linkage target information to the other of the first server and the second server is carried out in a case where the consent information is stored in the storage unit, and the provision process for providing the linkage target information to the other of the first server and the second server is not carried out in a case where the consent information is not stored in the storage unit.

10. The information processing method according to claim 9, wherein
in the acquiring, first authentication information used by the first server to authenticate the user and second authentication information used by the second server to authenticate the user are acquired, and
in the storing, the first authentication information, the second authentication information, and the linkage target information are stored in the storage unit in association with each other.

11. The information processing method according to claim 10, wherein
in the acquiring, in a case where a request for provision of the linkage target information is acquired from one of the first server and the second server and the consent information is stored in the storage unit,
a process for providing the linkage target information to the one of the first server and the second server is carried out in the provision process.

12. The information processing method according to claim 11, wherein in the provision process, the linkage target information is filtered with reference to activity information of the user, and the filtered linkage target information is provided.

13. The information processing method according to claim 11, wherein
the request includes a request from the first server, and
the provided linkage target information includes at least one receivable place at which a product that the user has purchased via a sales website provided by the first server is receivable and which is associated with the second authentication information.

14. The information processing method according to claim 11, wherein
the request includes a request from the first server, and
the provided linkage target information includes purchase data of the user at a place at which the user received a product that the user had purchased via a sales website provided by the first server.

15. An information processing method comprising:
acquiring, from a user, an instruction to purchase a product;
transmitting a request to a linkage server that links an information processing apparatus with another server;
acquiring, from the linkage server, at least one receivable place at which the product is receivable and which is associated with second authentication information that is associated with first authentication information used in the information processing apparatus to authenticate the user; and
presenting, to the user, presentation information including the at least one receivable place.

16. The information processing method according to claim 15, wherein
the presentation information includes:
the at least one receivable place that is associated with the second authentication information; and
the at least one receivable place that is unassociated with the second authentication information in such a manner as to be distinguishable from each other.

17. A non-transitory storage medium storing therein a program for causing a computer to carry out:
a storage process for storing consent information in a storage unit in a case where the consent information has been acquired, the consent information indicating consent of a user regarding linkage between a first server and a second server; and
an acquisition process for acquiring, from one of the first server and the second server, linkage target information that is to be subjected to information linkage,
the computer carrying out, in a case where the consent information is stored in the storage unit, a provision process for providing the linkage target information to the other of the first server and the second server, and not carrying out, in a case where the consent information is not stored in the storage unit, the provision process for providing the linkage target information to the other of the first server and the second server.

18. A non-transitory storage medium storing therein a program for causing a computer to carry out:
an acquisition process for acquiring, from a user, an instruction to purchase a product;
a transmission process for transmitting a request to a linkage server that links an information processing apparatus with another server;
an acquisition process for acquiring, from the linkage server, at least one receivable place at which the product is receivable and which is associated with second authentication information that is associated with first authentication information used in the information processing apparatus to authenticate the user; and
a presentation process for presenting, to the user, presentation information including the at least one receivable place.
